(19) United States
(12) Patent Application Publication
(10) Pub. No.: US 2012/0034010 A1
(43) Pub. Date: Feb. 9, 2012

(54) PRINTER

(75) Inventor: Haruo Hasegawa, Shizuoka (JP)

(73) Assignee: TOSHIBA TEC KABUSHIKI KAISHA, Tokyo (JP)

(21) Appl. No.: 13/161,680

(22) Filed: Jun. 16, 2011

(30) Foreign Application Priority Data
Aug. 6, 2010 (JP) 2010-177247

(51) Int. Cl. B41J 11/04

(52) U.S. Cl. 400/611

(57) ABSTRACT

Embodiments described herein are to a printer which includes a platen roller configured to be rotary-driven by a rotary drive source, and a transport roller provided at the upstream side of the platen roller in a paper feeding direction. The transport roller is configured to be rotary-driven by the rotary drive source. The printer further includes a pinch roller configured to be elastically urged against the transport roller. The pinch roller is configured to be rotary-driven by the rotary drive source.

### CROSS-REFERENCE TO RELATED APPLICATIONS

This application is based upon and claims the benefit of priority from Japanese Patent Application No. 2010-177247, filed on Aug. 6, 2010, the entire content of which is incorporated herein by reference.

### FIELD

Embodiments described herein relate generally to a printer.

### BACKGROUND

In the related art, there is known a printer which includes a transport roller and a pinch roller, each of which is disposed at the upstream side of a platen roller in a paper feeding direction. A paper is interposed between the transport roller and the pinch roller to be conveyed along the paper feeding direction.

Such a printer requires a mechanism to avoid the occurrence of for example, malfunction of the printer, paper slippage, paper jam or the like to provide a stable paper conveyance.

### BRIEF DESCRIPTION OF THE DRAWINGS

FIG. 1 is a block diagram showing a printer configuration according to an illustrative embodiment.

FIG. 2 is a perspective view showing a pinch roller block and a print block of a printer according to an illustrative embodiment.

FIG. 3 is another perspective view of the pinch roller block and the print block of the printer, as seen in a different view from that of FIG. 2.

FIG. 4 is a front view of a transport roller, a pinch roller and a torque transmitting mechanism of a printer according to an illustrative embodiment.

FIG. 5A is a side view showing a state in which teeth of a driving gear are relatively deeply engaged with those of a driven gear according to an illustrative embodiment.

FIG. 5B is a side view showing a state in which teeth of a driving gear are relatively slightly engaged with those of a driven gear according to an illustrative embodiment.

### DETAILED DESCRIPTION

According to one embodiment, a printer includes a platen roller configured to be rotary-driven by a rotary drive source, and a transport roller provided at the upstream side of the platen roller in a paper feeding direction. The transport roller is configured to be rotary-driven by the rotary drive source. The printer further includes a pinch roller configured to be elastically urged against the transport roller. The pinch roller is configured to be rotary-driven by the rotary drive source.

Embodiments will now be described in detail with reference to the drawings.

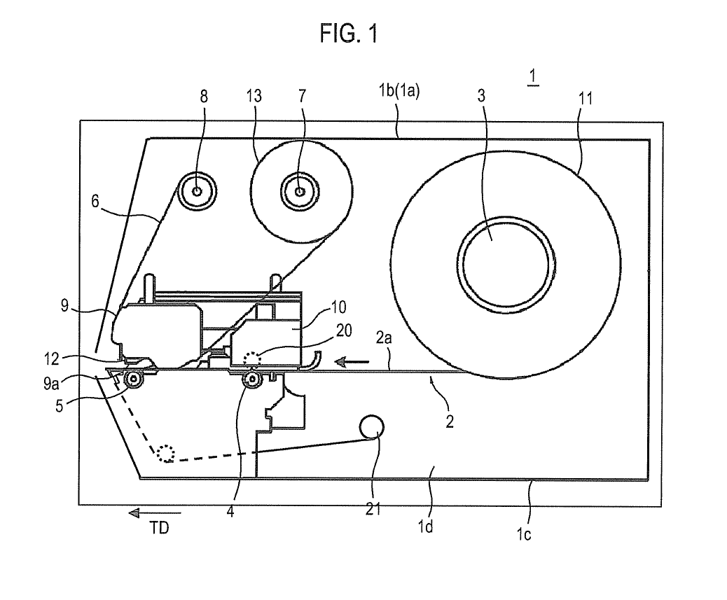

As shown in FIG. 1, a printer 1 of an illustrative embodiment may print on a label (used as a printing medium) provided (e.g., adhered to) on an inner surface 2a of a strip-shaped material 2 (e.g., paper). In some embodiments, the printer 1 may print on a printing medium other than a label, for example, a continuous-form paper without a backing sheet. In addition, the printer 1 may have a function of writing and reading data to and from an RFID (Radio Frequency IDentification) chip provided on a label.

As shown in FIG. 1, a main body 1a of the printer 1 may include a housing 1b having a bottom wall 1c and a side wall. The housing lb includes a longitudinal wall ld provided perpendicular to the bottom wall 1c and also parallel to the side wall. On the longitudinal wall 1d, a roll holding shaft 3, a transport roller 4, a platen roller 5, a supply shaft 7 for an ink ribbon 6, a take-up shaft 8 for the ink ribbon 6, a print block 9, a pinch roller block 10 and the like are disposed perpendicular to the longitudinal wall 1d. A control circuit may be provided on the rear side of the longitudinal wall 1d in the housing 1b, as seen from a front side of the plane view of FIG. 1.

The roll holding shaft 3 may rotatably hold a roll (e.g., paper roll) 11, around which the strip-shaped paper 2 is wound, in a state perpendicular to the plane of FIG. 1. In one embodiment, the roll holding shaft 3 may be rotatably supported by the longitudinal wall 1d. Alternatively, the roll holding shaft 3 may be fixed on the longitudinal wall ld, thereby allowing the paper roll 11 wound with the strip-shaped paper 2 to rotate around the roll holding shaft 3. In any of the above embodiments, the roll holding shaft 3 and the paper roll 11 are not driven by, for example, a motor. The paper roll 11 wound with the strip-shaped paper 2 rotates (or is driven) in conjunction with the rotation of the transport roller 4 and the platen roller 5, which are provided at the downstream side of the paper roll 11 in a paper feeding direction TD (e.g., the left direction in FIG. 1). As a result, the strip-shaped paper 2 is discharged from the paper roll 11.

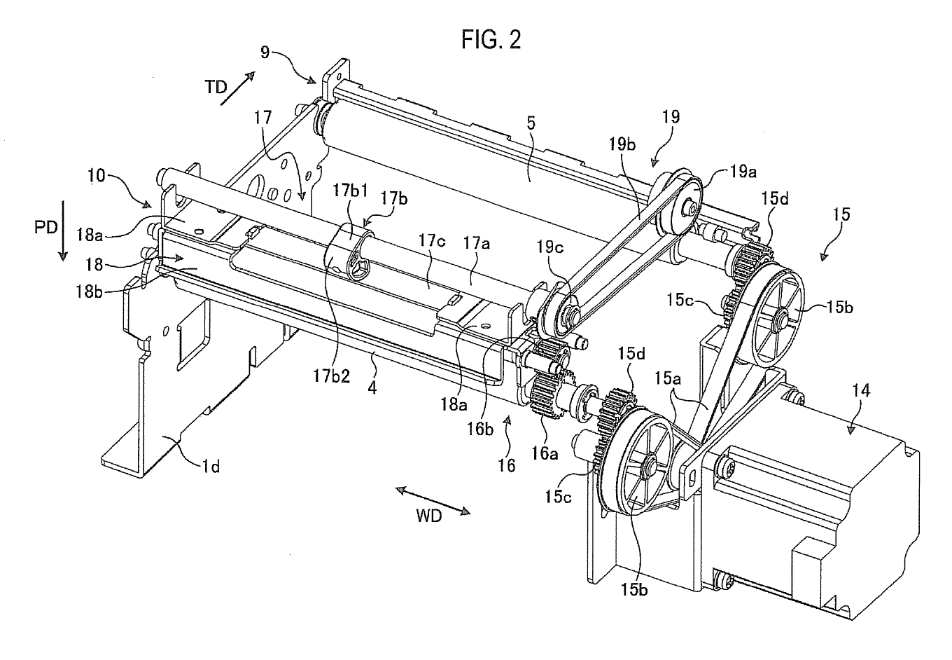

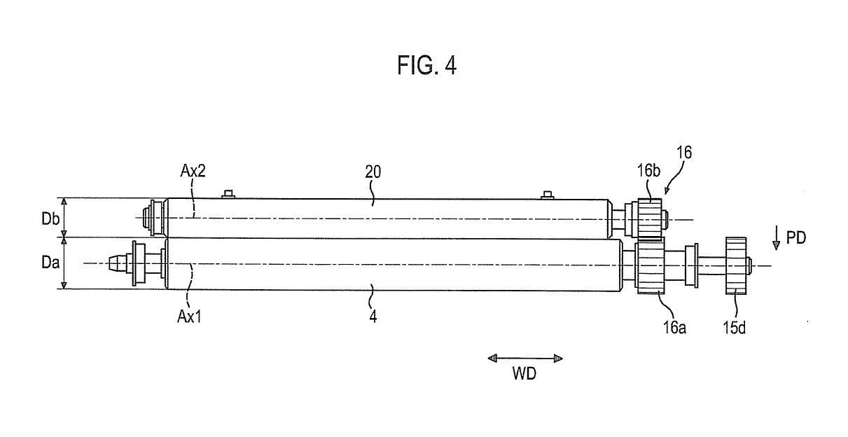

In the above embodiment, the transport roller 4, the platen roller 5 and a pinch roller 20 (see FIG. 4) may be rotary-driven by means of a rotary drive source (e.g., a motor 14 as shown in FIG. 2) through a torque transmitting mechanism. The transport roller 4 is provided at the upstream side of a print unit 12 and the platen roller 5 in the paper feeding direction TD. The pinch roller 20 is disposed in parallel and vertically adjacent to the transport roller 4, along the paper feeding direction TD. The pinch roller 20 is urged against the transport roller 4 with a predetermined pressure. The strip-shaped paper 2, interposed between the transport roller 4 and the pinch roller 20, is conveyed in the paper feeding direction TD in conjunction with the rotation of the transport roller 4 and the pinch roller 20. In this embodiment, the transport roller 4, the pinch roller 20, the platen roller 5, the motor 14, and a motor controller may constitute a conveying mechanism.

A ribbon roll 13, around which a strip-shaped material (e.g., ink ribbon 6) is wound, is held by the supply shaft 7 for the ink ribbon 6. The take-up shaft 8 may be rotary-driven by means of, for example, the motor 14. With the rotation of the take-up shaft 8, the ink ribbon 6 is discharged from the ribbon roll 13 and wound around the take-up shaft 8. Both the ink ribbon 6 and the strip-shaped paper 2 are interposed between a thermal head 9a included in the print block 9 and the platen roller 5. The thermal head 9a generates heat, which allows ink on the ink ribbon 6 to melt or sublimate. Through such operation of the thermal head 9a, a predetermined pattern such as a character, numeric character, bar code, or graphic, is transferred onto a label which is provided (e.g., attached) on a surface of the strip-shaped paper 2 (e.g., the inner surface 2a). In this embodiment, a print mechanism may include the ink ribbon 6, the supply shaft 7, the take-up shaft 8, the print block 9, the thermal head 9a, the motor 14, and the motor controller. The print unit 12 may include the thermal head 9a and the platen roller 5. A rewinder 21 may be provided to rewind a backing sheet that is detached from the strip-shaped material 2 being discharged from the paper roll 11. The rewinder 21 may be rotary-driven by the motor 14.

As stated above, the strip-shaped paper 2 is interposed between the transport roller 4 and the pinch roller 20, each of which is provided at the upstream side of the platen roller 5 in the paper feeding direction TD. According to the embodiment described above, the pinch roller 20 in addition to the transport roller 4 may be rotary-driven. In an arrangement of the related art, a pinch roller is disposed opposite a transport roller (with a paper interposed between the pinch roller and the transport roller) and is urged elastically against the transport roller, but it is not rotary-driven. That is, the pinch roller is driven in response to the discharge of the paper from a roll wound with the paper. Such an arrangement requires an increased urging force of the pinch roller against the transport roller so as to stably convey the paper interposed between the pinch roller and the transport roller. Unfortunately, the increased urging force causes an excessive gripping force applied to the paper by the pinch roller and the transport roller. As a result, a paper crease is prone to occur at the point of gripping, or a motor load required for the paper conveyance may increase significantly. In one embodiment according to the present disclosure, both the transport roller 4 and pinch roller 20 rotate in combination such that the urging force of the pinch roller 20 against the transport roller 4 is reduced compared to the pinch roller in the related art that does not rotate. Further, this reduces the above-described problems associated with the increased urging force.

As shown in FIG. 2, in one embodiment, when the motor 14 is energized, a torque (e.g., a rotational force) produced by the rotation of an output shaft of the motor 14 is transmitted to the transport roller 4 and the platen roller 5 by means of a first torque transmitting mechanism 15. The first torque transmitting mechanism 15 may include two sub-mechanisms corresponding to respective rollers (e.g., the transport roller 4 and the platen roller 5), each of which includes a driving pulley, an endless belt 15a, a driven pulley 15b, a driving gear 15c, and a driven gear 15d. The two driving pulleys are disposed in parallel with the axial direction of the output shaft of the motor 14. The two driven pulleys 15b are spaced apart from each other in the paper feeding direction TD. The endless belts 15a are stretched over the driving pulley and the driven pulley 15b for the transport roller 4, and over the driving pulley and the driven pulley 15b for the platen roller 5, respectively. The driving gears 15c are arranged to connect to the respective driven pulleys 15b and are engaged with the respective driven gears 15d. One of the two driven gears 15d, which is disposed at a more upstream side in the paper feeding direction TD, is arranged to connect to the transport roller 4. The other driven gear 15d, which is disposed at a more downstream side in the paper feeding direction TD, is arranged to connect to the platen roller 5. In this arrangement, a torque produced by the rotation of the output shaft of the motor 14 is transmitted to the transport roller 4 and the platen roller 5, through the two sub-mechanisms each formed by the driving pulley, the endless belt 15a, the driven pulley 15b, the driving gear 15c, and the driven gear 15d.

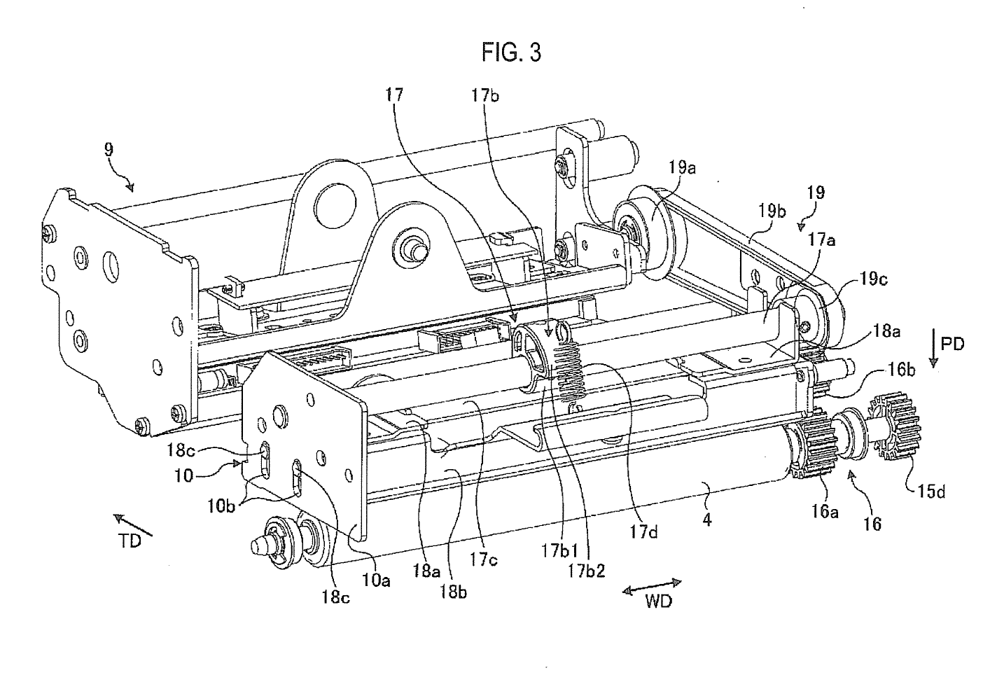

As shown in FIGS. 2 and 3, in one embodiment, the rotational force of the transport roller 4 is transmitted to the pinch roller 20 by means of a second torque transmitting mechanism 16, which includes a driving gear 16a and a driven gear 16b. The driving gear 16a is configured to connect to one end of the transport roller 4, and the driven gear 16b, which is engaged with the driving gear 16a, is configured to connect to one end of the pinch roller 20. Thus, the rotational force of the transport roller 4 can be transmitted to the pinch roller 20 through the driving gear 16a and the driven gear 16b.

The pinch roller 20 is rotatably supported by a pinch roller supporting member 18. The pinch roller supporting member 18 includes a main body 18b, which rotatably supports the pinch roller 20 and includes protrusions (e.g., provided in the opposite direction to the pinch roller 20) on the upper side of both ends of the pinch roller supporting member 18 in a widthwise direction WD of the strip-shaped paper 2. The pinch roller supporting member 18 further includes a pair of brackets 18a which are fixed on top of the main body 18b and at both sides of the pinch roller supporting member 18. A plate spring 17c is configured to connect to the pair of brackets 18a at both sides thereof. The pinch roller supporting member 18 further includes a pair of guiding members 18c (see FIG. 3) formed on a side plate 10a of the pinch roller block 10, each of which is vertically movable along a path defined by a vertically-elongated guide slot 10b. As such, the pinch roller supporting member 18 and the pinch roller 20 are supported by the pinch roller block 10 to vertically move along the path defined on the side plate 10a of the pinch roller block 10.

The pinch roller supporting member 18 is elastically urged against the transport roller 4 by means of an urging member 17. The urging member 17 includes a cam shaft 17a, a cam 17b, the plate spring 17c, and a coil spring 17d. The cam shaft 17a extends in the widthwise direction WD and is rotatably supported by the side plate 10a of the pinch roller block 10. The cam 17b is fixed at the center of the cam shaft 17a in the widthwise direction WD to rotate in conjunction with rotation of the cam shaft 17a. The cam 17b includes a base portion 17b1 and a protruding portion 17b2 protruding from the base portion 17b1 toward a radial outer side. The outer periphery surface of the cam 17b abuts on the plate spring 17c. The plate spring 17c has two surfaces each facing upward and downward, and extends along the widthwise direction WD. Both ends of the plate spring 17c in the widthwise direction WD are coupled to the pair of brackets 18a of the pinch roller supporting member 18, respectively. The coil spring 17d urges the main body 18b of the pinch roller supporting member 18 upward.

The cam 17b abuts on the center of the top surface of the plate spring 17c in the widthwise direction WD. When the protruding portion 17b2 of the cam 17b abuts on the plate spring 17c by the rotation of the cam shaft 17a, the plate spring 17c is urged downward (e.g., toward the transport roller 4). Thus, the cam 17b allows the pinch roller supporting member 18 and the pinch roller 20 to be elastically urged in the urging direction PD (e.g., downward in this embodiment) by means of the plate spring 17c. As a result, the pinch roller supporting member 18 and the pinch roller 20 are urged toward the transport roller 4. On the other hand, when the base portion 17b1 of the cam 17b abuts on the plate spring 17c by the rotation of the cam shaft 17a (or when the base portion 17b1 faces the top surface of the plate spring 17c without abutting on the plate spring 17c), the coil spring 17d allows the pinch roller supporting member 18 and the pinch roller 20 to be lifted toward the side opposite to the urging direction PD (e.g., upward in this embodiment). As a result, the pinch roller supporting member 18 and the pinch roller 20 are lifted in a direction away from the transport roller 4.

The rotation of the cam 17b (and the cam shaft 17a) may be switched according to the operation of an urging force switching mechanism 19. The urging force switching mechanism 19 includes a driving pulley 19a, an endless belt 19b, and a driven pulley 19c. The driving pulley 19a, which is rotatably supported by the print block 9, may rotate in conjunction with the rotation of an operating lever which switches the urging of the thermal head 9a toward the platen roller 5. The endless belt 19b is stretched between the driving pulley 19a and the driven pulley 19c so that the rotation of the driving pulley 19a is transmitted to the driven pulley 19c. The driven pulley 19c, which is rotatably supported by the pinch roller block 10, is coupled to the cam shaft 17a. Thus, the rotation of the driven pulley 19c allows the cam shaft 17a and the cam 17b to rotate. As a result, according to this embodiment, the urging force switching mechanism 19 may switch an urging condition of the print block 9 toward the platen roller 5 into a non-urging condition, and vice-versa. Further, according to this embodiment, the urging force switching mechanism 19 may switch an urging condition of the pinch roller 20 toward the transport roller 4 into a non-urging condition, and vice-versa.

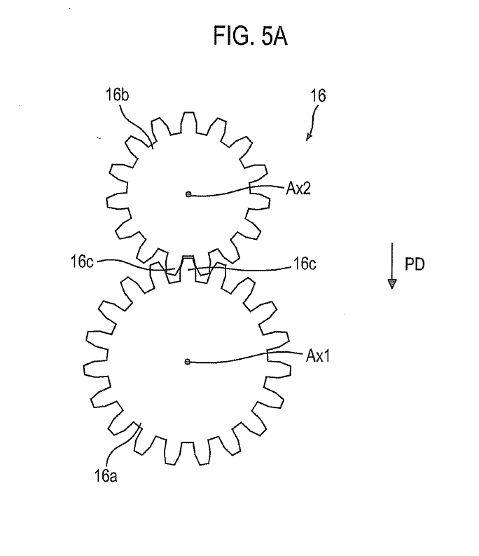

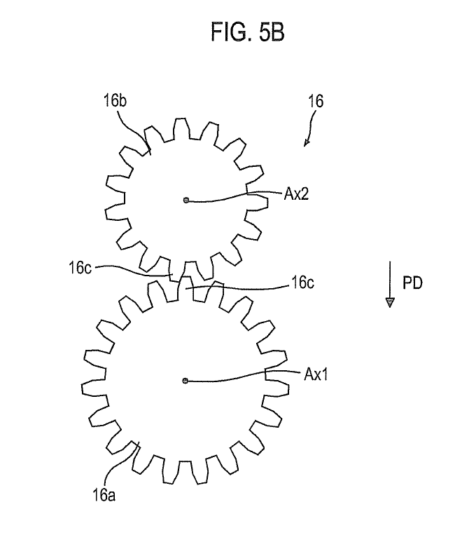

As shown in the embodiments illustrated in FIGS. 4 and 5, the transport roller 4 and the pinch roller 20 may be arranged in the urging direction PD (e.g., up and down directions), and the driving gear 16a and the driven gear 16b of the second torque transmitting mechanism 16 may be arranged in the urging direction PD. As described above, the pinch roller 20 is elastically urged toward the transport roller 4 by means of the urging member 17. The strip-shaped paper 2 including a printing medium such as a label may be interposed between the pinch roller 20 and the transport roller 4. In this arrangement, in accordance with the variation of the thickness of the strip-shaped paper 2 depending on the presence or absence of a label, the pinch roller 20 may move toward or away from the transport roller 4 whose rotational center is fixed in a printing state. In the embodiment shown in FIG. 5, the driving gear 16a and the driven gear 16b are arranged in the urging direction PD. FIG. 5A shows a state in which teeth 16c of the driving gear 16a are relatively deeply engaged with teeth 16c of the driven gear 16b. FIG. 5B shows a state in which the teeth 16c of the driving gear 16a are relatively slightly engaged with the teeth 16c of the driven gear 16b. In this embodiment, the rotational center Ax2 of the driven gear 16b may move toward or away, along the urging direction PD, from the rotational center Ax1 of the driving gear 16a having a fixed position during printing, according to the variation in the thickness of the strip-shaped paper 2. However, as shown in FIGS. 5A and 5B, the rotational force of the driving gear 16a may be transmitted to the driven gear 16b as long as the teeth 16c of the gears 16a and 16b are engaged with each other. Further, as the diameter Da of the transport roller 4 is set to be different from the diameter Db of the pinch roller 20, the respective diameters of the gears 16a and 16b may also vary, as shown in FIGS. 5A and 5B. In one embodiment, the number of the respective teeth of the gears 16a and 16b may be selected such that circumferential speeds of the transport roller 4 and the pinch roller 20 are equal to each other at a portion where the transport roller 4 faces the pinch roller 20 (e.g., a portion where the strip-shaped paper 2 is interposed between the transport roller 4 and the pinch roller 20).

Further, in the embodiment shown in FIG. 4, the diameter Db of the pinch roller 20 is set to be smaller than the diameter Da of the transport roller 4. As described above, the pinch roller supporting member 18 and the urging member 17 are disposed above the pinch roller 20. In this arrangement, setting the diameter Db of the pinch roller 20 to be smaller than the diameter Da of the transport roller 4 allows the arrangement of the printer 1 to be structurally uncomplicated at the top of the pinch roller 20. Moreover, this arrangement allows the size of the printer 1 to be smaller.

As mentioned in the above embodiment, the pinch roller 20 may be elastically urged against the transport roller 4 while it is driven to rotate. This may reduce the urging force of the pinch roller 20 against the transport roller 4 compared to the case where the pinch roller 20 is not rotary-driven, which in turn inhibits creasing on the strip-shaped paper 2 or reduces motor load.

Further, in the above embodiment, the second torque transmitting mechanism 16 may be configured to transmit the rotational force of the transport roller 4 to the pinch roller 20. This allows the pinch roller 20 to be rotary-driven in a relatively simplified fashion.

Furthermore, in the above embodiment, the second torque transmitting mechanism 16 may include the driving gear 16a, which is provided at the side of the transport roller 4, and the driven gear 16b, which is disposed at the side of the pinch roller 20 and is in engagement with the driving gear 16a. This arrangement implements the second torque transmitting mechanism 16 in a relatively simplified fashion.

Moreover, in the above embodiment, the driving gear 16a and the driven gear 16b are engaged with each other in the urging direction PD from the pinch roller 20 to the transport roller 4. This allows the pinch roller 20 to be separated from the transport roller 4 while the driving gear 16a is still engaged with the driven gear 16b. Therefore, it is possible to implement the second torque transmitting mechanism 16, which allows a displacement of the pinch roller 20 relative to the transport roller 4 according to the variation in thickness of the strip-shaped paper 2 and, at the same time, allows transmission of the rotational force of the transport roller 4 to the pinch roller 20.

In another embodiment, the diameter Db of the pinch roller 20 is set to be smaller than the diameter Da of the transport roller 4. This configuration allows the pinch roller supporting member 18 which supports the pinch roller 20 at the side opposite to the transport roller 4, or the urging member 17 which elastically urges the pinch roller 20 against the transport roller 4, to be structurally uncomplicated. Moreover, this configuration allows the size of the printer 1 to be smaller.

In yet another embodiment, the urging member 17 includes the plate spring 17c. This arrangement allows implementation of an elastic member to elastically urge the pinch roller 20 against the transport roller 4, an arrangement to support the elastic member, or an arrangement to urge the elastic member, in a relatively simplified fashion.

While certain embodiments have been described, these embodiments have been presented by way of example only, and are not intended to limit the scope of the inventions. Indeed, the embodiments described herein may be embodied in a variety of other forms. For example, the urging member which elastically urges the pinch roller against the transport roller 4, may include an elastic member other than a plate spring (e.g., a coil spring, an elastomer, etc.). Furthermore, the location at which the plate spring is disposed, or the location to which an urging force is applied by an urging member such as a cam, may be changed without departing from the spirit of the inventions. In addition, the torque transmitting mechanism may be implemented by employing a belt drive mechanism. Still further, the torque transmitting mechanism may be implemented by a member including three or more gears. The pinch roller may be rotary-driven by different torque driving mechanisms and different torque transmitting mechanisms from the aforementioned embodiments, without being rotary-driven by the strip-shaped paper. Furthermore, the pinch roller and the transport roller may be rotary-driven by different torque driving mechanisms and different torque transmitting mechanisms from the aforementioned embodiments. As an example, the platen roller, the transport roller and the pinch roller may be rotary-driven by individual torque driving mechanisms and individual torque transmitting mechanisms, respectively. Alternatively, the platen roller, the transport roller and the pinch roller may be rotary-driven by different torque transmitting mechanisms each being driven by a single torque driving mechanism. Furthermore, the specification (a scheme, structure, shape, size, length, depth, thickness, cross-section area, weight, number, material, arrangement, location or the like) of a component (a printer, a paper, a platen roller, a transport roller, a pinch roller, a torque transmitting mechanism, a driving gear, a driven gear, an urging member, a plate spring or the like) may be modified in a variety of other forms.

The accompanying claims and their equivalents are intended to cover such forms or modifications as would fall within the scope and spirit of the inventions.

What is claimed is:

1. A printer, comprising:
a platen roller configured to be rotary-driven by a rotary drive source;
a transport roller provided at the upstream side of the platen roller in a paper feeding direction and configured to be rotary-driven by the rotary drive source; and
a pinch roller configured to be elastically urged against the transport roller and further configured to be rotary-driven by the rotary drive source.

2. The printer of claim 1, further comprising: a first transmitting mechanism configured to transmit a rotational force of the rotary drive source to the transport roller and the pinch roller.

3. The printer of claim 2, wherein the first transmitting mechanism includes a driving gear connected to the transport roller, and a driven gear connected to the pinch roller, wherein the driving gear is configured to be engaged with the driven gear.

4. The printer of claim 3, wherein the driving gear and the driven gear are engaged with each other in a direction in which the pinch roller is urged against the transport roller.

5. The printer of claim 1, further comprising: a second transmitting mechanism configured to transmit the rotational force of the rotary drive source to the transport roller, the pinch roller, and the platen roller.

6. The printer of claim 1, wherein the diameter of the pinch roller is smaller than the diameter of the transport roller.

7. The printer of claim 1, wherein the pinch roller is urged against the transport roller by a plate spring.

8. The printer of claim 1, wherein when a printing medium is interposed between the transport roller and the pinch roller and wherein the printing medium is conveyed with rotation of the transport roller and the pinch roller in the paper feeding direction.

9. The printer of claim 8, wherein the pinch roller is displaced relative to the transport roller according to the variation in thickness of the printing medium being conveyed.

10. The printer of claim 1, further comprising:
an urging member having a plate spring, configured to urge the pinch roller against the transport roller by the plate spring.

11. The printer of claim 10, wherein the rotational center of the transport roller is fixed during printing and the rotational center of the pinch roller is varied according to the variation of the thickness of a printing medium while the printing medium is being conveyed interposed between the transport roller and the pinch roller.

12. A printer, comprising:
a transport roller and a pinch roller, configured to convey a printing medium between the transport roller and the pinch roller;
a motor configured to generate a rotational force;
a transmitting mechanism configured to transmit the rotational force to the transport roller and the pinch roller such that the printing medium is conveyed between the transport roller and the pinch roller.

13. The printer of claim 12, further comprising: a platen roller configured to be driven by the motor.

14. The printer of claim 12, further comprising: an urging member configured to urge the pinch roller against the transport roller.

15. The printer of claim 12, wherein the transmitting mechanism includes a driving gear connected to the transport roller and a driven gear connected to the pinch roller, wherein the driving gear is configured to be engaged with the driven gear to transmit the rotational force of the transport roller to the pinch roller.

16. The printer of claim 15, wherein the diameter of the driven gear is smaller than the diameter of the driving gear.

17. The printer of claim 16, wherein the rotational center of the transport roller is fixed during printing and the rotational center of the pinch roller is varied according to the variation of the thickness of the printing medium while the strip-shaped material is being conveyed between the transport roller and the pinch roller.

18. A printer, comprising:
a first roller having a first gear at one end;
a second roller having a second gear at one end, the second roller being disposed with respect to the first roller to convey a printing medium therebetween; and
a drive source configured to drive the first roller such that the second roller is driven by the first and second gears in engagement with each other.

19. The printer of claim 18, wherein the first roller is a transport roller and the second roller is a pinch roller.

20. The printer of claim 19, wherein the diameter of the first gear is larger than the diameter of the second gear.
